(19) United States
(12) Patent Application Publication
(10) Pub. No.: US 2015/0188204 A1
(43) Pub. Date: Jul. 2, 2015

(54) BATTERY HEATING DEVICE

(71) Applicant: Panasonic Intellectual Property Management Co., Ltd., Osaka-shi, Osaka (JP)

(72) Inventor: Masaki Hanada, Aichi (JP)

(21) Appl. No.: 14/414,349

(22) PCT Filed: Jul. 12, 2013
(86) PCT No.: PCT/JP2013/004313

§ 371 Date: Jan. 12, 2015

(30) Foreign Application Priority Data
Jul. 13, 2012 (JP) 2012-157185

(51) Int. Cl. H01M 10/625; B60L 11/18; H05B 1/02; H05B 3/20

(52) U.S. Cl. CPC H01M 10/625; H01M 10/6571; H01M 10/615; H05B 1/0236; H05B 3/20; B60L 11/1875; H01M 2220/20

(57) ABSTRACT

A battery heating device which heats a battery having a plurality of battery modules, comprises a planar heating element configured with: a resistor sheet including; an electric insulating base sheet, a polymer resistor having the PTC characteristics which is placed on the electric insulating base sheet, and a pair of electrodes for energizing the polymer resistor, said electrodes being placed as extending in parallel each other on the polymer resistor, and a uniformly-heating plate attached to the resistor sheet, wherein the uniformly-heating plate has a length that is longer than a length of the resistor sheet by twice or more.

### TECHNICAL FIELD

The present invention relates to a battery heating device, for example, which heats a battery of a car or the like in the cold district.

### BACKGROUND ART

Conventionally, for example, in a battery mounted on a car, there is a possibility that a battery liquid is frozen under the condition that a temperature becomes minus 30 degrees Celsius (−30 deg. C) or less. Even if the battery liquid is not frozen, there is a possibility that a car cannot start up due to significant lowering of an electric capacity of the battery. Therefore, it has been considered to prevent a performance of the battery from being lowered by heating the battery itself using an auxiliary heating source such as a battery heating device.

As this kind of the battery heating device, for example, a planar heating element as illustrated in FIG. 7 and FIG. 8 is known (for example, refer to Patent Document 1). As illustrated in FIG. 7, a conventional planar heating element 111 includes a heat dissipating plate 101, two disc like heating elements 102 which are electrically connected each other by a lead wire 105, a lead wire 103 which is electrically connected to the lead wire 105 with capability to feed the lead wire 105, a lead wire 104 which is electrically connected to the heat dissipating plate 101 by using the heat dissipating plate 101 as an electrode. As the heating element 102, a ceramic PTC (Positive Temperature Coefficient) heating element is used, and, for example, it is formed in a disc shape.

The conventional planar heating elements 111 configured in the above-mentioned manner are, as shown in FIG. 8, respectively placed on the both side surfaces of the battery 113 which faces each other, and the battery 113 and the planar heating elements 111 are covered with insulating material 112. The lead wires 103, 104 are electrically connected to the battery 113, and each of the planar heating elements 111 heats the battery 113 by using the battery 113 itself as an electric power source.

### Patent Document(s)

Patent Document 1: JP H09-190841 A

### SUMMARY OF THE INVENTION

### Problems to be Solved by the Invention

Recently, in order to correspond to the demand for saving energy or reducing CO2, there has been increased an interest in a hybrid car in which an engine and a motor are combined, and in an electric car in which only a motor is power source or the like. For the batteries mounted in these cars, an electric capacity need to be large for driving the motor. Accordingly, a battery with a high voltage and a large electric capacity is achieved by the manner that a battery unit in which a battery module composed of several batteries connected in series is contained in a case as one unit is formed, and further a plurality of such battery units are connected in series (if necessary, further connected in parallel).

Even in the battery with high electric capacity, there is a problem that an electric capacity of the battery is lowered in the severe environment with a low temperature, which is the same as the ordinary batteries. Therefore, it is considered to heat a battery by the means disclosed in the Patent Document 1.

In the planar heating element 111 of the Patent Document 1, however, as configured such that a pair of the ceramic PTC heating elements 102 is placed on the heat dissipating plate 101, difference of the temperature tends to be generated between a part located close to heating element 102 in the heat dissipating plate 101 and a peripheral part of the heat dissipating plate 101. In Particular, in the configuration such that the ceramic PTC heating element 102 is applied as a PTC heating element, it is difficult to enlarge the heating element itself according to characteristics of ceramic. Therefore, in the case of heating the batteries configured to have a plurality of battery units with a multiple layer construction, which are used for the hybrid car, the electric car or the like, difference of the temperature is generated between each battery unit. Therefore, it causes the problem that recovery of the electric capacity is not enough as a total battery.

The present invention is made to overcome the above-mentioned conventional problems and in a battery heating device which heats batteries having a plurality of battery modules, the present invention aims at providing a battery heating device which can suppress uneven heating to the degree that there is practically no problem with a simple configuration.

### Means to Solve the Problems

In order to solve the above-mentioned problem, a battery heating device for heating a battery having a plurality of battery modules, comprises a planar heating element configured with: a resistor sheet including; an electric insulating base sheet, a polymer resistor having the PTC characteristics which is placed on the electric insulating base sheet, and a pair of electrodes for energizing the polymer resistor, said electrodes being placed as extending in parallel each other on the polymer resistor, and a uniformly-heating plate attached to the resistor sheet, wherein the uniformly-heating plate has a length that is longer than a length of the resistor sheet by twice or more.

### Effects of the Invention

According to the present invention, in a battery heating device which heats batteries having a plurality of battery modules, it can suppress uneven heating to the degree that there is practically no problem with a simple configuration.

### BRIEF DESCRIPTION OF THE DRAWINGS

FIG. 1 is a plan view illustrating a configuration of a battery heating device (a planar heating element) according to the embodiment (the working example 1) of the present invention.

FIG. 2 is a perspective view illustrating a status that a battery heating device according to the embodiment is installed on a battery.

FIG. 3 is a plan view illustrating a configuration of a battery heating device according to the working example 2 of the present invention.

FIG. 4 is a plan view illustrating a configuration of a battery heating device according to the comparative example 1.

FIG. 5 is a plan view illustrating a configuration of a battery heating device according to the comparative example 2.

FIG. 6 is a graph illustrating a temperature distribution of the planar heating element according to the working example 1, the comparative example 1 and the comparative example 2.

FIG. 7 is a plan view illustrating a conventional planar heating element.

FIG. 8 is a side view illustrating a conventional planar heating element.

### EMBODIMENTS FOR CARRYING OUT THE INVENTION

A battery heating device according to the first invention is a battery heating device for heating a battery having a plurality of battery modules, comprises a planar heating element configured with: a resistor sheet including; an electric insulating base sheet, a polymer resistor having the PTC characteristics which is placed on the electric insulating base sheet, and a pair of electrodes for energizing the polymer resistor, said electrodes being placed as extending in parallel each other on the polymer resistor, and an attached to the resistor sheet, wherein the uniformly-heating plate has a length that is longer than a length of the resistor sheet by twice or more.

According to the configuration as described above, it can suppress generation of local concentration of a temperature (“hot line”) between the pair of the electrodes which extends on the polymer resistor of the resistor sheet, it can heat the battery with equalizing the temperature distribution to the condition that there is practically no problem in a wide range, and thereby suppressing uneven heating. Since heat generated at the polymer resistor of the resistor sheet is diffused to the periphery of the polymer resistor by the uniformly-heating plate, it can lower a stable temperature of the heated portion of the polymer resistor, and thereby enhancing the safety. At the same time, since it can lower a resistance value of the polymer resistor by keeping the temperature of the part where heat is generated low, it can enlarge the output of the planar heating element.

In the second invention, particularly according to the battery heating device of the first invention, wherein in the resistor sheet, an area placed between the pair of the electrodes is a heat generating portion, a length of the uniformly-heating plate in the direction to be orthogonal to the extending direction of the electrodes is larger than a length of the heat generating portion in the direction to be orthogonal to the extending direction of the electrodes by twice or more.

If the resistor sheet is formed as being long in the extending direction of the electrodes, the number of the pair of the electrodes can be reduced, and thereby achieving a rather simple configuration. Therefore, as a resistor sheet, many resistor sheets have been formed as being long in the extending direction of the electrodes. Therefore, by forming the uniformly-heating plate such that a length thereof is longer than that of the heat generating portion in the direction to be orthogonal to the extending direction of the electrodes, the uniformly-heating plate can be formed such that an area of a heat diffusing surface thereof becomes large in comparison with the case that the uniformly-heating plate is formed as being long in the extending direction of the electrodes. Accordingly, the stable temperature of the heat generating portion of the polymer resistor can be made lower, and the safety is enhanced as well as the output of the planar heating element can be enlarged.

In the third invention, particularly according to the battery heating device of the first or second invention, wherein in the resistor sheet, an area placed between the pair of the electrodes is a heat generating portion, a length of the uniformly-heating plate in the extending direction of the electrodes is larger than a length of the heat generating portion in the extending direction of the electrodes by twice or more.

According to the configuration as described above, since the uniformly-heating plate is formed as extending in the extending direction of the electrodes to be orthogonal to the direction between the electrodes, it can suppress the heat concentration (“hot line”: the heat concentration generated due to the uneven temperature distribution in the direction of voltage application) between the pair of the electrodes efficiently, and thereby enhancing the reliability.

In the fourth invention, particularly according to the battery heating device of any one of the first to third inventions, wherein a center portion of the heat generating portion of the resistor sheet and a center portion of the uniformly-heating plate are placed in the same location at least in one direction of the directions to be orthogonal to the extending direction of the electrodes and the extending direction of the electrodes.

According to the configuration as described above, since the center portion of the uniformly-heating plate in the direction where the length thereof is extended is placed in the same location as the center portion of the heat generating portion of the resistor sheet, the heat generated by the polymer resistor can be transmitted to the uniformly-heating plate more uniformly. Therefore, in the planar heating element, a temperature distribution can be stabilized and uneven heating can be reduced.

In the fifth invention, particularly according to the battery heating device of any one of the first to third inventions, wherein a connecting portion which connects feeding lead wires to the electrodes of the resistor sheet is provided, in the resistor sheet, edge portions in which the connecting portions are formed are placed close to an edge of the uniformly-heating plate.

According to the configuration as described above, wiring process of the feeding lead wires can be performed easily, and uneven heating can be suppressed by the simple configuration.

In the sixth invention, particularly according to the battery heating device of any one of the first to fourth inventions, wherein the planar heating element is placed with the battery, having a distance of 4 mm or less between the planar heating element and a surface to be heated of the battery.

According to the configuration as described above, it can suppress the leakage of the heated air to outside through the space by reducing the space between the surface to be heated of the battery and the planar heating element, and thereby concentrating the heat to the surface to be heated of the battery. Therefore, the battery can be heated efficiently.

Hereinafter, embodiments of the present invention will be described, with reference to the accompanying drawings. The present invention will not be limited by the embodiments of the present examples.

### Embodiment

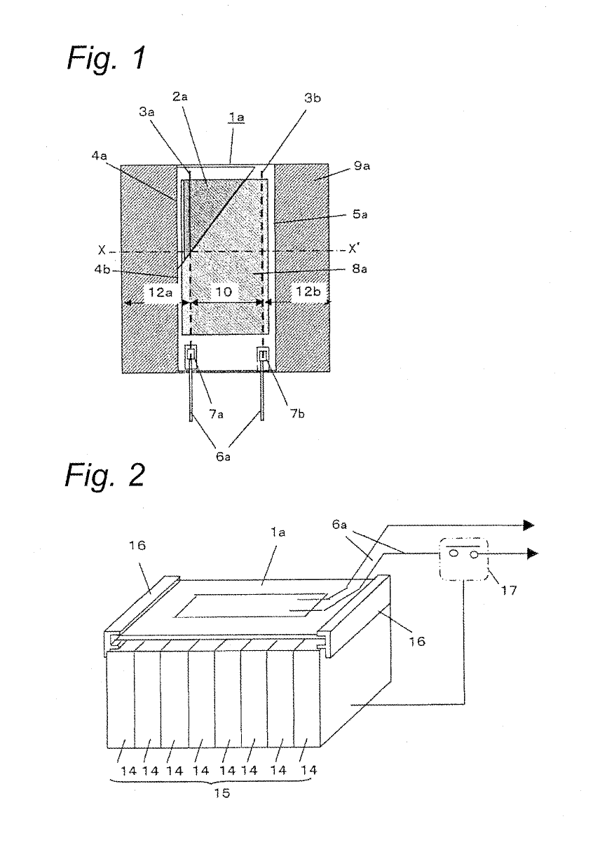

A battery heating device according to the embodiment of the present invention will be described, with reference to FIG. 1 and FIG. 2.

FIG. 1 is a plan view illustrating a battery heating device according to the embodiment, and shows a status that a part of an electric insulating base sheet 4b is broken. FIG. 2 is a perspective view illustrating a status that the battery heating device is installed on a battery 15. In FIG. 2, there is shown a configuration of the battery heating device which has a uniformly-heating plate 9a further extending to the extending direction of electrodes of a resistor sheet 5a in comparison with the battery heating device illustrated in FIG. 1. The battery heating device with the configuration as illustrated in FIG. 1 can be placed in the case of FIG. 2.

As illustrated in FIG. 1, a planar heating element 1a as the battery heating device comprises the resistor sheet 5a, and the uniformly-heating plate 9a formed by a material with a high heat conductivity such as aluminum or the like.

The resistor sheet 5a comprises a polymer resistor 2a, a pair of electrode wires 3a, 3b, the electric insulating base sheets 4a, 4b which cover the polymer resistor 2a and the electrode wires 3a, 3b by sandwiching them from both sides.

The polymer resistor 2a is formed by a material which has the PTC (Positive Temperature Coefficient) characteristics, and for example, formed in a film shape by mixing and kneading a resin material and a conductive carbon material. In the polymer resistor 2a, if a temperature is raised, an electric resistance value is also raised, and if a temperature is lowered, an electric resistance value is also lowered. Therefore, the polymer resistor 2a has a self-temperature control function to stabilize at a predetermined temperature.

The electrode wires 3a, 3b are formed as being extended to the same direction on the polymer resistor 2a. Thus, the pair of the electrode wires 3a, 3b are placed in parallel each other with a predetermined distance 10 on the polymer resistor 2a. As the electrode wires 3a, 3b, for example, a copper stranded wire is used. In the following description, the direction where the electrode wires 3a, 3b are extended on a surface of the polymer resistor 2a (thus, the up and down direction in FIG. 1) is defined as an extending direction of the electrodes.

For example, the electric insulating base sheets 4a, 4b are formed by a material such as polyethylene terephthalate or the like. A bonding process (a thermocompression bonding process) which is a process to bond the electric insulating base sheets 4a, 4b to the polymer resistor 2a and the electrode wires 3a, 3b, is applied, by performing a hot pressing or a heat laminating process on the condition that a hot melt material is applied on connection surfaces of the electric insulating base sheets 4a, 4b and the polymer resistor 2a.

As illustrated in FIG. 1, connecting portions 7a, 7b which are feeding terminals are provided at one end (the end located at the lower side in FIG. 1) of the electrode wires 3a, 3b in the resistor sheet 5a. Close to one end of the resistor sheet 5a, the polymer resistor 2a does not exist, and further a cutting off portion is formed in the electric insulating base sheets 4a, 4b so as to expose each end of the electrode wires 3a, 3b. Each of the connecting portion 7a, 7b is connected to feeding lead wires 6a electrically and physically by soldering, spot welding, swaging with use of a sleeve end terminal or the like.

The uniformly-heating plate 9a is attached to one surface of the resistor sheet 5a using an adhering means such as a double-faced adhesive tape. The uniformly-heating plate 9a is preferably formed in a sheet shape with a material with high heat conductivity. In the embodiment, for example, the uniformly-heating plate 9a is formed by an aluminum sheet with 0.5 mm thickness.

The polymer resistor 2a of the resistor sheet 5a has a function to generate heat when the electrode wires 3a, 3b are energized. A rectangular part (area) defined by the distance 10 between the electrode wires 3a and 3b and the both ends of the electrode wires 3a, 3b in the direction to be orthogonal to the extending direction of the electrodes is called “a heat generating portion 8a” specifically as a part which contributes heat generation in the polymer resistor 2a.

As illustrated in FIG. 1, the uniformly-heating plate 9a is formed having the same length as the length of the resistor sheet 5a in the extending direction of the electrodes, and having a length further extending beyond the length of the resistor sheet 5a in the direction between the electrode wires 3a, 3b (the direction between the electrodes: which means the direction to be orthogonal to the extending direction of the electrodes, and the left to right direction in FIG. 1). Specifically, the uniformly-heating plate 9a has a length to be three times longer than a length of the resistor sheet 5a. Thus, a ratio of the length of the uniformly-heating plate 9a to the length of the heat generating portion 8a in the direction between the electrodes is 3, and a ratio of an area of the uniformly-heating plate 9a to an area of the heat generating portion 8a is 3.4. As illustrated in FIG. 1, in the planar heating element 1a, the areas located at the outside of the electrode wires 3a, 3b (thus, the area at the both ends in the left to right direction) becomes non-heating areas 12a, 12b where heat is not generated by the polymer resistor 2a.

The polymer resistor 2a is not simply limited to a film, and there can be provided a configuration to attach a reinforcing member such as nonwoven clothes to reinforce the polymer resistor 2a, a configuration to lay a reinforcing member such as nonwoven cloths in the film of the polymer resistor 2a, or a configuration to use a reinforcing member in which a material formed such that a resin material and a conductive carbon are mixed and kneaded is impregnated with a material such as nonwoven clothes.

The electrode wires 3a, 3b can be coated wires in which the same material or similar material of the polymer resistor 2a is coated thereto instead of the copper stranded wires in order to enhance an adhesiveness between the electrode wires 3a, 3b and the polymer resistor 2a. If a planar heating element 1a is used in the place where flexibility is not required so much, a copper single wire or a copper flat wire can also be used. A metal other than copper can also be used as a material of the electrode wire.

In the embodiment, while the same electric insulating base sheet is used as the electric insulating base sheet 4a, 4b, an electric insulating base sheet having different thickness each other according to the necessity can also be used, and other material which can maintain the function can be used as a material of the electric insulating base sheet.

A copper material can be used to the uniformly-heating plate 9a in order to enhance uniformly-heating characteristics. Thickness of the uniformly-heating plate 9a can be increased in order to enhance rigidity. Thickness of the uniformly-heating plate 9a can be decreased in order to lower the cost.

A notch, a marking, a hole or the like can be applied to the uniformly-heating plate 9a in order to give a marking when the resistor sheet 5a is attached.

FIG. 2 is a perspective view illustrating a status that the planar heating element 1a is installed on a battery 15. The battery 15 which is an object to be heated is configured such that a plurality of battery modules 14 in which a plurality of battery cells are connected in series are laminated. The planar heating element 1a is fixed by support of a supporting member 16 on the condition that the planar heating element 1a faces one surface (a surface to be heated) of the battery 15 with a distance of 3 mm between the surface to be heated of the battery 15 and the planar heating element 1a. The supporting element 16 and the planar heating element 1a can be fixed each other using a fastening means or a fixing means. For example, through holes are placed at the position where the resistor sheet 5a does not exist in the uniformly-heating plate 9a, and the supporting element 16 and the planar heating element 1a can be fixed by fastening bolts and nuts.

The planar heating element 1a is installed such that the uniformly-heating plate 9a is located at the battery module 14 side in comparison with the resistor sheet 5a. Therefore, under the condition that the battery 15 and the planar heating element 1a are mounted in a car, the resistor sheet 5a does not contact the battery module 14 even if the uniformly-heating plate 9a is bent due to vibration of the car, and thereby preventing from adversely affecting performance of the resistor sheet 5a such as insulating performance of the resistor sheet 5a or the like.

A temperature detecting means (a temperature detector, not illustrated) is provided in the battery 15, and the control means (the controller) 17 controls electric power supply to the planar heating element 1a with receiving the temperature information from the temperature detecting means. Thus, the control means 17 controls on/off switching of electric power supply to the planar heating element 1a based on a preset temperature condition and the detected temperature information. Instead of using the control means in the above-mentioned manner, on/off switching of electric power supply to the planar heating element 1a can be selected according to the intention of a user.

Hereinafter, performance and function of the planar heating element as configured in the above-mentioned manner will be described.

If a temperature of the battery 15 detected by the temperature detecting means (not illustrated) becomes a preset temperature or less, the control means 17 starts electric power supply to the planar heating element 1a, and if a temperature of the planar heating element 1a reaches a predetermined temperature, it stops electric power supply to the planar heating element 1a.

When electric power supply to the planar heating element 1a starts, generation of heat is started by the heat generating portion 8a located between the electrode wires 3a and 3b of the polymer resistor 2a. The heat generated by the heat generating portion 8a is transmitted to the uniformly-heating plate 9a, and the heat distribution is equalized by the uniformly-heating plate 9a as well as the heat is transferred to the surface to be heated of the battery 15 via the clearance.

Since the polymer resistor 2a has the PTC characteristics, when a certain time period has passed after starting electric power supply to the planar heating element 1a, a heating amount is lowered due to increase of electric resistance value of the polymer resistor 2a according to rise of the temperature. Accordingly, a stable temperature that an amount of heat generation and an amount of heat dissipation are balanced is maintained. Thus, in the polymer resistor 2a, the stable temperature is determined depending on the dissipating heat amount, and the heat amount generated by the polymer resistor 2a can be enlarged if it can apply a construction which can enlarge the dissipating heat amount. In addition to the function of suppressing uneven heating, the planar heating element 1a according to the embodiment has the uniformly-heating plate 9a which has a length longer than that of the heat generating portion 8a of the resistor sheet 5a in order to enlarge the dissipating heat amount.

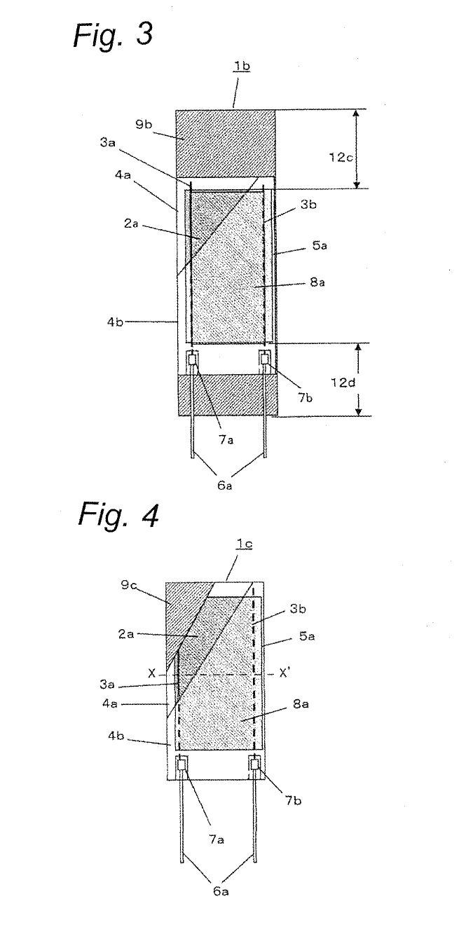

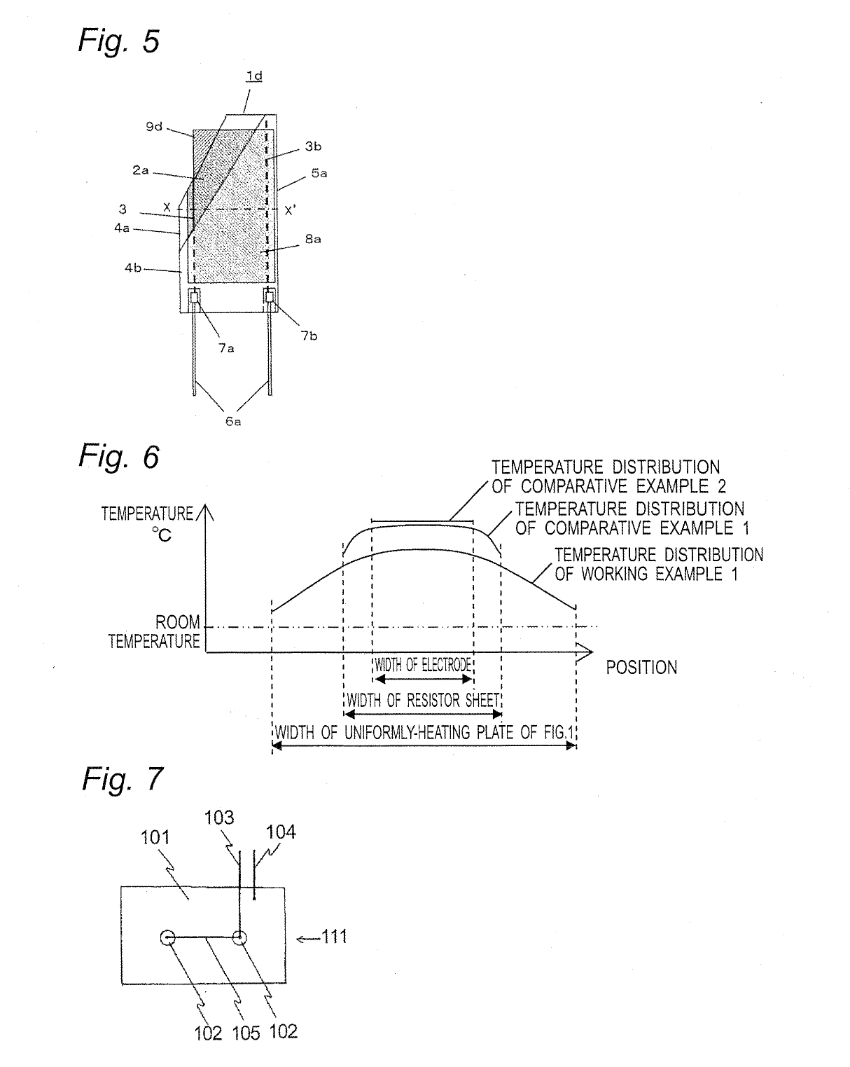

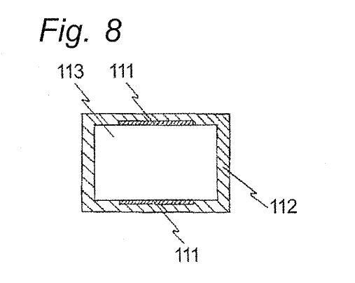

In order to verify the above-mentioned advantageous effects of the planar heating element according to the present invention, planar heating elements 1a (working example 1: refer to FIG. 1) and 1b (working example 2: refer to FIG. 3) according to the working examples of the present invention, and planar heating elements 1c (comparative example 1: refer to FIG. 4) and 1d (comparative example 2: refer to FIG. 5) according to the comparative examples have been formed, and comparison of performance of each planar heating element has been performed.

The planar heating element 1a, 1b, 1c, and 1d as illustrated in FIG. 1 and FIGS. 3 to 5 are configured such that the resistor sheet 5a which has the same shape and the same size is attached to the uniformly-heating plates 9a, 9b, 9c, and 9d which have different shapes and different sizes.

As illustrated in FIG. 1, a sample as described below is used as the resistor sheet 5a; the distance 10 between the pair of the electrode wires is 50 mm, the length in the extending direction of the electrodes is 200 mm, and the output of 40 W is obtained at 20 degrees Celsius as a temperature of the resistor in a single body of the resistor sheet 5a (thus, under the condition that the uniformly-heating plate is not attached.) In the planar heating element 1a, 1b of the working examples 1 and 2 as illustrated in FIGS. 1 and 3, there is shown the status that the polymer resistor 2a is exposed by virtually breaking a part of the electric insulating base sheet 4b. In the planar heating elements 1c, 1d of the comparative examples 1 and 2 as illustrated in FIGS. 4 and 5, there is shown the status that the uniformly-heating plates 9c, 9d are exposed by virtually breaking a part of the electric insulating base sheet 4b and in addition to it, by virtually breaking a part of the polymer resistor 2a and a part of the electric insulating base sheet 4a.

A plate of A5020 (JIS standard) material which has 0.5 mm thickness is used as the uniformly-heating plates 9a, 9b, 9c,9d.

In the planar heating element 1a of the working example 1 as illustrated in FIG. 1, the uniformly-heating plate 9a is formed having approximately the same dimension as a length of the resistor sheet 5a in the extending direction of the electrode (the same dimension allows that a margin for manufacturing, or difference of length due to manufacturing tolerance exists). On the contrary, in the direction between the electrode wires 3a and 3b (the direction to be orthogonal to the extending direction of the electrodes), the non-heating area 12a, 12b is provided by extending the length of the uniformly-heating plate 9a. Specifically, a ratio of the length of the uniformly-heating plate 9a to the length of the heat generating portion 8a in the direction between the electrodes is 3, and a ratio of the area of the uniformly-heating plate 9a to the area of the heat generating portion 8a is 3.4.

In the planar heating element 1b of the working example 2 as illustrated in FIG. 3, the uniformly-heating plate 9b is formed having approximately the same dimension as a length of the electric insulating base sheet 5a in the direction between the electrodes (the same dimension allows that a margin for manufacturing, or difference of length due to manufacturing tolerance exists). In the extending direction of the electrodes, the non-heating area 12c 12d are provided by extending the length of the uniformly-heating plate 9b. Specifically, it is formed such that a ratio of the length of the uniformly-heating plate 9b to the length of the heat generating portion 8a in the extending direction of the electrodes is 2, and a ratio of the area of the uniformly-heating plate 9b to the area of the heat generating portion 8a is approximate 2.6.

In the planar heating element 1c of the comparative example 1 as illustrated in FIG. 4, the uniformly-heating plate 9c is formed having approximately the same dimension as the resistor sheet 5a both in the extending direction of the electrodes and the direction between the electrode wires 3a and 3b. A ratio of the area of the uniformly-heating plate 9c to the area of the heat generating portion 8a is approximate 1.5.

In the planar heating element 1d of the comparative example 2 as illustrated in FIG. 5, the uniformly-heating plate 9d is formed having approximately the same dimension as the heat generating portion 8a both in the extending direction of the electrodes and the direction between the electrode wires 3a and 3b. A ratio of the area of the uniformly-heating plate 9d to the area of the heat generating portion 8a is approximate 1.0.

In Table 1, there is shown a result of measurement of the output when the a planar heating element is energized for 5 minutes under the condition that an ambient temperature during the measurement is −20 degrees Celsius, and the planar heating element is suspended without placing the battery 15 which is a object to be heated. As the result of Table 1, there is shown a ratio (a ratio of the output) on the condition that the output of the planar heating element 1d of the comparative example 2 as illustrated in FIG. 5 is 100%. A temperature distribution of each planar heating element at measuring the output (a temperature distribution of the section X-X′ in FIG. 1, FIG. 4, FIG. 5) is illustrated in FIG. 6. The vertical axis shows a temperature, and the horizontal axis shows a position in the direction of sectional surface.

TABLE 1
Ratio of Area and Ratio of Output of Sheet-like Heating Element

| | | Ratio of Area | Ratio of Output |
|---|---|---|---|
| | | Uniformly-heating | compared to |
| | | plate/Heat | Comparative |
| | | generating | working |
| No. | Configuration | portion | example 2 |
| Comparative | Uniformly-heating | 1 | 100% |
| example 2 | plate = Heat | | |
| (FIG. 5) | generating portion | | |
| Comparative | Uniformly-heating | 1.5 | 130% |
| example 1 | plate = Resistor | | |
| (FIG. 4) | sheet | | |
| Working | Uniformly-heating | 2.6 | 150% |
| example 2 | plate extends in | | |
| (FIG. 3) | extending direction | | |
| | of electrodes | | |
| Working | Uniformly-heating | 3.4 | 170% |
| example 1 | plate extends in | | |
| (FIG. 1) | direction between | | |
| | electrodes | | |

As shown in Table 1, there has been obtained a result that if the ratio of the uniformly-heating plate to the heat generating portion becomes larger, the ratio of the output becomes larger (thus, the heating amount becomes larger). Since the polymer resistor 2a has the PTC characteristics, the heat generated by the heat generating portion 8a of the polymer resistor 2a is diffused by the uniformly-heating plate, and thereby lowering the stable temperature of the resistor sheet. Accordingly, as clearly illustrated in FIG. 6, if the ratio of the area of the uniformly-heating plate to the heat generating portion is larger, the heat dissipating amount (the heat diffusing amount) becomes larger, and thereby lowering the stable temperature. Therefore the output (the heating amount) of the resistor sheet can be increased.

As illustrated in FIG. 6, the maximum temperature in the stable temperature is almost the same in the planar heating element 1c of the comparative example 1 as illustrated in FIG. 4 and the planar heating element 1d of the comparative example 2 as illustrated in FIG. 5. On the contrary, in the planar heating element 1a of the working example 1 as illustrated in FIG. 1, it can be recognized that since the heat of the resistor sheet 5a is transmitted to the non-heating area 12a, 12b of the uniformly-heating plate 9a and diffused, the maximum temperature in the stable temperature becomes low. By lowering the maximum temperature of the stable temperature in the above-mentioned manner, it can prevent the temperature from being raised excessively, or the local concentration of the temperature from being generated, and thereby dissolving the uneven heating and enhancing the reliability during heating the battery 15. While the stable temperature of the planar heating element 1b of the working example 2 as illustrated in FIG. 3 is not shown in FIG. 6, the temperature distribution of the stable temperature of the planar heating element 1b of the working example 2 is a little bit lower than that of the planar heating element 1c of the comparative example 1 as illustrated in FIG. 4.

As the result of measuring the output, the planar heating element 1b of the working example 2 as illustrated in FIG. 3 can obtain the output to be 150% (1.5 times) compared to the planar heating element 1d of the comparative example 2 as illustrated in FIG. 5. The planar heating element 1a of the working example 1 as illustrated in FIG. 1 can obtain the output to be 170% (1.7 times) compared to the planar heating element 1d of the comparative example 2 as illustrated in FIG. 5. In particular, it can be recognized that if a length of the uniformly-heating plate is longer than that of the resistor sheet by twice or more, it can obtain the output to be enough higher than the comparative examples 1, 2. In the configuration as mentioned above, since a large output can be obtained with a simple configuration, it can reduce an area of the resistor sheet required for obtaining a desired output, and also reduce the cost.

In the planar heating element 1a, 1b of the working example 1, 2 as illustrated in FIG. 1 and FIG. 3, the center portion of the heat generating portion 8 and the center portion of the uniformly-heating plates 9a, 9b are placed in approximately identified position (the condition of identified allows a certain displacement in the manufacturing or the like) at least in one direction of the extending direction of the electrodes and the direction to be orthogonal to the extending direction of the electrodes. As mentioned above, since the large output can be obtained by performing the heat dissipation efficiently with the uniformly-heating plate, the uniformly-heating plate can dissipate the heat more efficiently by providing a portion without the heat generating portion at the both sides of the resistor sheet, and can raise the output amount.

Next, the planar heating element 1a of the working example 1 as illustrated in FIG. 1 and the planar heating element 1b of the working example 2 as illustrated in FIG. 3 are compared. The polymer resistor itself is formed such that a dimension in the extending direction of the electrodes is larger than that in the direction between the electrodes. In the planar heating element 1a of the working example 1 as illustrated in FIG. 1, the effect of the heat transmission and the heat dissipation is enhanced by extending the uniformly-heating plate 9a in the direction between the electrodes. In particular, since the non-heating area 12a, 12b (a part to dissipate heat) having a large area can be placed at the area located close to the heat generating portion 8a (a part to generate heat), the effect of high heating dissipation can be obtained, and the large heating amount can be obtained with keeping the stable temperature low. Since there is a limitation to enlarge the distance 10 between the pair of the electrode wires 3a, 3b, a plurality of the pair of the electrode wires further need to be provided in the case that a length of the planar heating element is enlarged in the direction between the electrodes. However since the uniformly-heating plate is extended in the direction between the electrodes as shown in the working example 1, the heating area of the planar heating element 1a in the direction between the electrodes can enlarged without providing the pair of the electrodes additionally.

The planar heating element 1b of the working example 2 as illustrated in FIG. 3 can suppress a “hot line” (a problem such as the heat concentration due to the uneven temperature distribution in the direction of voltage application (the direction between the electrodes)) which is an inherent problem of the planar heating element having the PTC characteristics by making the uniformly-heating plate 9b longer in the extending direction of the electrodes than that in the direction between the electrodes. In particular, the configuration such that the uniformly-heating plate 9b is not placed outside of the pair of the electrodes 3a, 3b can enhance the uniformity of the temperature distribution in the direction between the electrodes in the area between the pair of the electrode wires 3a, 3b (the heat generating portion 8a). The effect of the heat dissipation is enhanced and the large output can be obtained by extending the uniformly-heating plate 9b in the extending direction of the electrodes and thereby providing the non-heating area 12c, 12d thereon. By adopting the configuration as mentioned above, it can enhance the uniformity of the temperature in the direction between the electrodes and suppress the generation of the “hot line” phenomenon, and thereby raising the reliability. Since the “hot line” is generated by non-uniformity of the temperature and it is likely to be generated when the distance between the electrodes is long, it is preferable to design to shorten the distance between the electrodes.

As illustrated in FIG. 2, the planar heating element 1a has a construction to be fixed by the supporting member 16, for example, having a distance of 3 mm to the battery 15, and to cover almost all of one surface (the surface to be heated) of the battery 15. According to such configuration, air in the space between the battery 15 and the planar heating element 1a is heated by the planar heating element 1a, and the battery 15 is heated via the air in the space. Since it is formed such that the space between the surface to be heated of the battery 15 and the planar heating element 1a is 3 mm which is narrow, an amount of air flowing out from the space is small. According to the result of the devoted study of the inventor, it is recognized that if the space between the surface to be heated of the battery 15 and the planar heating element 1a is 4 mm or less, an amount of air which flows out (flowing out from the space) is small, and the battery 15 can be heated efficiently.

Thus, by placing the uniformly heating element 9a such that the space between the surface to be heated of the battery 15 and the planar heating element 1a is 4 mm or less, the uniformly-heating plate 9a can have not only a function to transmit the heat generated by the uniformly heating element 1a, but also an outflow prevention function to prevent the heated air in the space between the battery 15 and the planar heating element 1a from flowing out.

As illustrated in FIG. 2, the uniformly-heating plate 9a can be formed to be twice larger both in the extending direction of electrodes and the direction between the electrodes. In this configuration, it is preferable that the resistor sheet 5a is placed at approximately center of the uniformly-heating plate 9a in order to enhance the heat dissipating efficiency.

While the uniformly-heating plate 9a, 9b in the working example 1, 2 are exemplified as a flat plate, the effect of the present invention can be obtained if a ratio of the area between the heat generating portion 8a and the uniformly-heating plates 9a, 9b is maintained, and thus, the uniformly-heating plate 9a, 9b and the resistor sheet 5a may be bent and a notch may be placed therein.

The resistor sheet may have a configuration such that the end portions in which the connecting portions 7a, 7b are formed are located at the end of the uniformly-heating plate, so as to perform a wiring operation to connect the feeding lead wire 6a to the connecting portion more easily.

Further, while in the above-mentioned embodiment, the planar heating element 1a is installed in the battery 15 via the supporting element 16, it may be configured such that the planar heating element is installed in an insulative body made of plastics or the like, and the battery is covered with the body which is fixed at the battery side. By installing the planar heating element such that the resistor sheet is placed between the body and the uniformly-heating plate, it can prevent the contact of the resistor sheet to an element located outside of the body such as a battery case or the like, and thereby enhancing the reliability of the resistor sheet.

According to the embodiment of the present invention, even if a material for the resistor is not adjusted, the output amount of the planar heating element can be adjusted by adjusting a dimension of the uniformly-heating plate. In particular, by determining a suitable direction to extend a length of the uniformly-heating plate relative to the extending direction of the electrodes, the planar heating element corresponding to the feature of the polymer resistor having the PTC characteristics can be provided. Therefore, since it can heat the battery efficiently as well as it can lower the stable temperature, the reliability can be enhanced. Further, since an area of the resistor sheet required to obtain a desired output can be made smaller, the planar heating element to be superior in material cost can be easily provided.

By combining any embodiment in the above-mentioned embodiments arbitrarily, the effect of each embodiment can be achieved.

Relating to the preferred embodiments, while the present invention is fully described with referring to the attached drawings, any change or adjustment from the embodiments will be clear to persons skilled in the art. It should be considered that such change or adjustment is included therein unless it deviates from the scope of the present invention according to the attached claims.

The disclosure of the specification, drawings and claims of JP No. 2012-157185 which was filed on Jul. 13, 2012 should be generally referred and incorporated into the present specification.

### INDUSTRIAL APPLICABILITY

As mentioned above, since the planar heating element according to the present invention can adjust a heating amount generated by a planar heating element using a polymer resistor having the PTC characteristics by adjusting a shape or a size of a uniformly-heating plate, it can increase the heating amount per unit area of the planar heating element as well as it can lower a stable temperature. Accordingly, since the safe and reliable planar heating element without a risk of excessive rise of the temperature can be provided, it can be applied to heating of batteries for hybrid cars, electric cars or the like for the cold district, as well as it is widely applied as other heaters for heating.

### EXPLANATION OF REFERENCE NUMERALS

1a, 1b, 1c, 1d planar heating element
2a polymer resistor
3a, 3b electrode wire
4a, 4b electric insulating base sheet
5a resistor sheet
6a feeding lead wire
7a, 7b connecting portion
8a heat generating portion
9a, 9b, 9c, 9d uniformly-heating plate
12a to 12d non-heating area
14 battery module
15 battery
16 supporting member
17 control means

1. A battery heating device for heating a battery having a plurality of battery modules, comprising:
a planar heating element, comprising:
a resistor sheet which comprises an electric insulating base sheet, a polymer resistor on the electric insulating base sheet, and a pair of electrodes for energizing the polymer resistor, the polymer resistor exhibiting PTC characteristics, and the electrodes extending in parallel with each other on the polymer resistor, and
a uniformly-heating plate in contact with the resistor sheet,
wherein the uniformly-heating plate has at least one dimension that is longer than a corresponding dimension of the resistor sheet by twice or more.

2. The battery heating device according to claim 1, wherein
in the resistor sheet, an area between the pair of the electrodes is a heat generating portion, and
a length of the uniformly-heating plate in a direction orthogonal to an extending direction of the electrodes is larger than a length of the heat generating portion in the direction orthogonal to the extending direction of the electrodes by twice or more.

3. The battery heating device according to claim 1, wherein
in the resistor sheet, an area between the pair of the electrodes is a heat generating portion,
a length of the uniformly-heating plate in an extending direction of the electrodes is larger than a length of the heat generating portion in the extending direction of the electrodes by twice or more.

4. The battery heating device according to claim 1, wherein
in the resistor sheet, an area between the pair of the electrodes is a heat generating portion and a center portion of the heat generating portion of the resistor sheet and a center portion of the uniformly-heating plate are at the same position in at least one of (a) a direction orthogonal to an extending direction of the electrodes and (b) the extending direction of the electrodes.

5. The battery heating device according to claim 1, further comprising
a pair of connecting portions for connecting feeding lead wires to the pair of electrodes of the resistor sheet, wherein
the connecting portions are present at an edge of the resistor sheet adjacent an edge of the uniformly-heating plate.

6. (canceled)

7. A battery assembly, comprising:
a battery;
the battery heating device according to claim 1; and
a support structure that supports the battery heating device adjacent a surface of the battery to be heated.

8. The battery assembly according to claim 7, wherein the battery comprises a plurality of adjacent battery modules, and a single battery heating device is provided for the plurality of battery modules.

9. The battery assembly according to claim 7, wherein the support structure supports the battery heating device so as to be spaced from the surface of the battery to be heated.

10. The battery assembly according to claim 9, wherein the battery is a battery for an electric motor-driven automobile or an engine-electric motor hybrid automobile, and the support structure supports the battery heating device so as to be spaced no more than 4 mm from the surface of the battery to be heated.

11. The battery assembly according to claim 7, further comprising a battery temperature detector and a controller that receives battery temperature information from the battery temperature detector and starts power supply to the pair of electrodes when the temperature is less than a predetermined minimum.

12. An automobile, comprising;
a drive system that is electric motor-driven or engine-electric motor hybrid; and
the battery assembly according to claim 7.
